(19) United States
(12) Patent Application Publication
(10) Pub. No.: US 2001/0034707 A1
(43) Pub. Date: Oct. 25, 2001

(54) Card utilization approval method, card settlement system and card authentication and settlement processing device

(75) Inventor: Ikuo Sakaguchi, Tokyo (JP)

Correspondence Address: YOUNG & THOMPSON, 745 SOUTH 23RD STREET 2ND FLOOR, ARLINGTON, VA, 22202

(73) Assignee: NEC CORPORATION

(21) Appl. No.: 09/838,185

(22) Filed: Apr. 20, 2001

(30) Foreign Application Priority Data
Apr. 25, 2000 (JP) 124731/2000

(51) Int. Cl. G06F 17/60

(52) U.S. Cl. 705/44; 235/380; 455/403

(57) ABSTRACT

A card information of a card 11 to be settled is read by a payment processing terminal 12 and sent to a card authentication and settlement processing device 13. The card authentication and settlement processing device 13 calls a mobile station 21 of an owner of the card through a mobile phone mediating server 3 by using a card information of the card. By inputting a password and a settlement information from the mobile station 21, the card authentication and settlement processing device 13 performs a payment settlement.

### BACKGROUND OF THE INVENTION

1. Field of the Invention

The present invention relates to a card utilization approval method and card settlement system by means of a mobile phone and, particularly, to a purchase and payment method and a card settlement system utilizing a card for settlement such as credit card or IC card, etc.

2. Description of the Related Art

A conventional card purchase and payment system utilizing a card such as credit card or IC card has a construction including an authentication and settlement processor which, when a card information and an information including an amount of payment is inputted to the authentication and settlement processor, the authentication of the same card and the payment information are printed and, when an owner of the card signs the print, the authentication and the payment settlement in the authentication and settlement processor becomes possible.

However, there are the following problems in the conventional purchase and payment system using the credit card or IC card:

1) In the purchase and payment system, the owner of the credit card or IC card has to temporarily hand the credit card or IC card to a store clerk when he utilizes the card and it is impossible to directly confirm how the card is handled by the store clerk. Therefore, a possibility of unauthorized copy or illegal use of the card inheres in the conventional purchase and payment system.

2) The conventional purchase and payment system employs a system in which a specification of purchase using the card is printed out. Therefore, it is impossible to directly receive or utilize the specification of purchase as electronic data.

3) Since the settlement processing for a credit card or IC card is based on the fact that the owner of the card is the same as the user of the card, it is impossible to execute a purchase and a payment by a third person in lieu of the owner.

### SUMMARY OF THE INVENTION

An object of the present invention is to provide a card utilization approval method, a card settlement system and a card authentication and settlement processing device, with which a trouble such as illegal copy or illegal use of a credit card or IC card by an unauthorized third person can be prevented.

Another object of the present invention is to provide a card utilization approval method, a card settlement system and a card authentication and settlement processing device, with which a specification of utilization of a credit card or IC card can be directly received or utilized as electronic data.

A further object of the present invention is to provide a card utilization approval method, a card settlement system and a card authentication and settlement processing device, with which a third person can perform purchase and payment in lieu of an owner of the card.

According to a first aspect of the present invention, a card utilization approval method is provided, which is featured by that, upon an input of a card information of a settlement card such as a credit card or an IC card and a card authentication to a card authentication and settlement processing device, a mobile station of an owner of the settlement card is called by the card authentication and settlement processing device and a payment processing is performed in the card authentication and settlement processing device by a password or ID number assigned to the owner, which is inputted from the called mobile station.

It is preferable to perform a mediation of call from the card authentication and settlement processing device to a mobile phone system and a conversion of a format of the data from the authentication and settlement processing device into a format corresponding to a display function of the mobile station by a mobile phone mediating server provided between the authentication and settlement processing device and the mobile phone system.

Further, it is preferable that the mobile station is connectable to an internet and has a browser function with which an information of purchase and payment can be displayed thereon in detail.

According to a second aspect of the present invention, a card settlement system is provided, which comprises a payment processing terminal for reading a card information from a settlement card and a card authentication and settlement processing device for performing an authentication of payer and a payment on the basis of the card information from the payment processing terminal and is featured by that the authentication and settlement processing device comprises means for calling a mobile station of an owner of the card in a mobile phone system by using the card information and means for performing an authentication and a confirmation of payment according to an input from the called mobile station.

It is preferable that the card settlement system further comprises a mobile phone mediating server for establishing a connection between the card authentication and settlement processing device and the mobile phone system and performing a mediation of call from the card authentication and settlement processing device to the mobile station and a conversion of a format of the data from the authentication and settlement processing device into a format corresponding to a display function of the mobile station.

It is preferable that the mobile phone mediating server comprises means for transferring an information of purchase, payment and settlement from the card authentication and settlement processing device to the called mobile station in a format corresponding a display function of the called mobile station.

Operations of the payment processing terminal, the card authentication and settlement processing device, the mobile phone mediating server and the mobile station will be described briefly.

1) The payment processing terminal reads the card information of such as ID and residue, etc., from the credit card or the IC card and transmits the information to the card authentication and settlement processing device together with the purchase and payment data.

2) The card authentication and settlement processing device transmits the purchase and payment data to the mobile station through the mobile phone mediating server.

3) The mobile station allows the user to confirm the purchase and payment data on the mobile station by an operation of the user, to perform a payment approval operation and to send a payment approval signal to the card authentication and settlement processing device through the mobile phone mediating server.

4) The card authentication and settlement processing device determines whether a settlement is possible or not by verifying the card information (ID and residue, etc.) sent from the payment processing terminal and the payment approval signal with reference to a database of the device.

5) The card authentication and settlement processing device sends the determination of the settlement to the mobile station and the payment processing terminal and displays it thereon.

6) When the determination is that the settlement is possible, the card authentication and settlement processing device updates the content of settlement in the database thereof and sends the settlement data to a bank's database. The transmission system of the settlement data to the bank's database can be set arbitrarily to any of online, offline, immediate and batch systems according to the operating system employed thereby.

7) When the determination is that the settlement is impossible, it is not recorded in the database of the card authentication and settlement processing device. In such case, a reason for impossibility of settlement is displayed on the mobile station together with a warning of shortage of residue and illegal usage of the card by the owner himself or a third party, etc.

8) It is possible, by operating the mobile station, to update a payable limit of the credit card or the residue data of the IC card by collating with the database of the authentication and settlement processing device through the mobile phone mediating server or the bank's database and take the updated data in the side of the mobile station.

According to the third aspect of the present invention, a card authentication and settlement processing device is featured by comprising means for calling a mobile station of an owner of the card in the mobile phone system using the card information for settlement and means for performing the processing of card authentication and settlement of payment according to an information inputted from the called mobile station.

### BRIEF DESCRIPTION OF THE DRAWINGS

An embodiment of the present invention will be described with reference to the accompanying drawings, in which:

FIG. 1 shows an embodiment of the present invention;

FIG. 2 is a flowchart of a card authentication and settlement processing; and

FIG. 3 is a flowchart of a processing of an inquiry from a mobile station.

### DETAILED DESCRIPTION OF THE PREFERRED EMBODIMENTS

Description of Construction

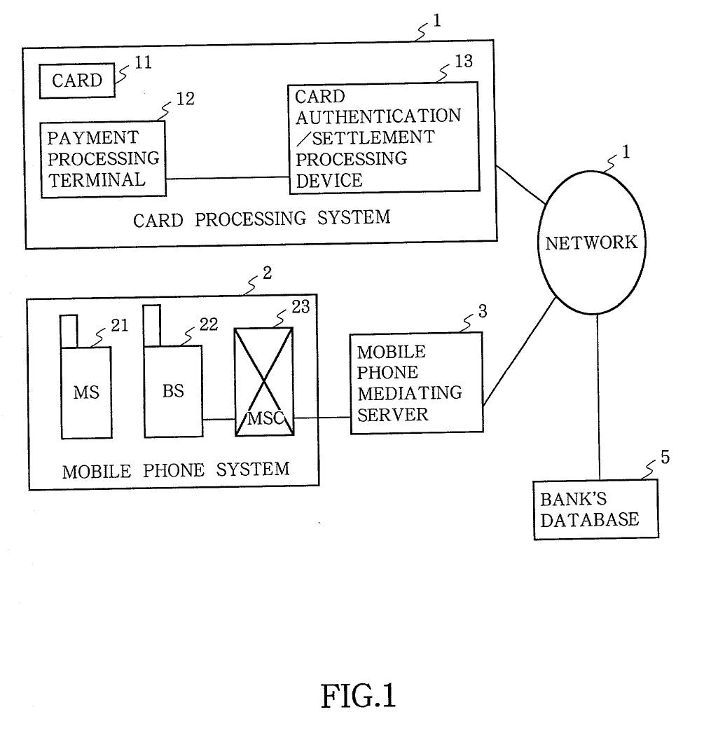

FIG. 1 shows a construction of an embodiment of the present invention. This embodiment comprises a card processing system 1, a mobile phone system 2, a mobile phone mediating server 3 and a communication network 4. The card processing system 1 includes a payment processing terminal 12 for reading a card information from a card 11 and a card authentication and settlement processing device 13 for performing an authentication of a payer and a payment settlement on the basis of the card information from the payment processing terminal 1 and the card authentication and settlement processing device 13 is connected to the communication network 4. The mobile phone system 2 comprises a mobile station (MS) 21, a base station (BS) 22 and a mobile switching center (MSC) 23, which is connected to the communication network 4 through the mobile phone mediating server 3. Further, the communication network 4 is connected to a bank's database 5. The payment processing terminal 12 is connected to the card authentication and settlement processing device 13 through a telephone circuit or a dedicated circuit and the mobile switching center 23 is connected to the mobile phone mediating server 3 through a dedicated circuit.

Description of Operation

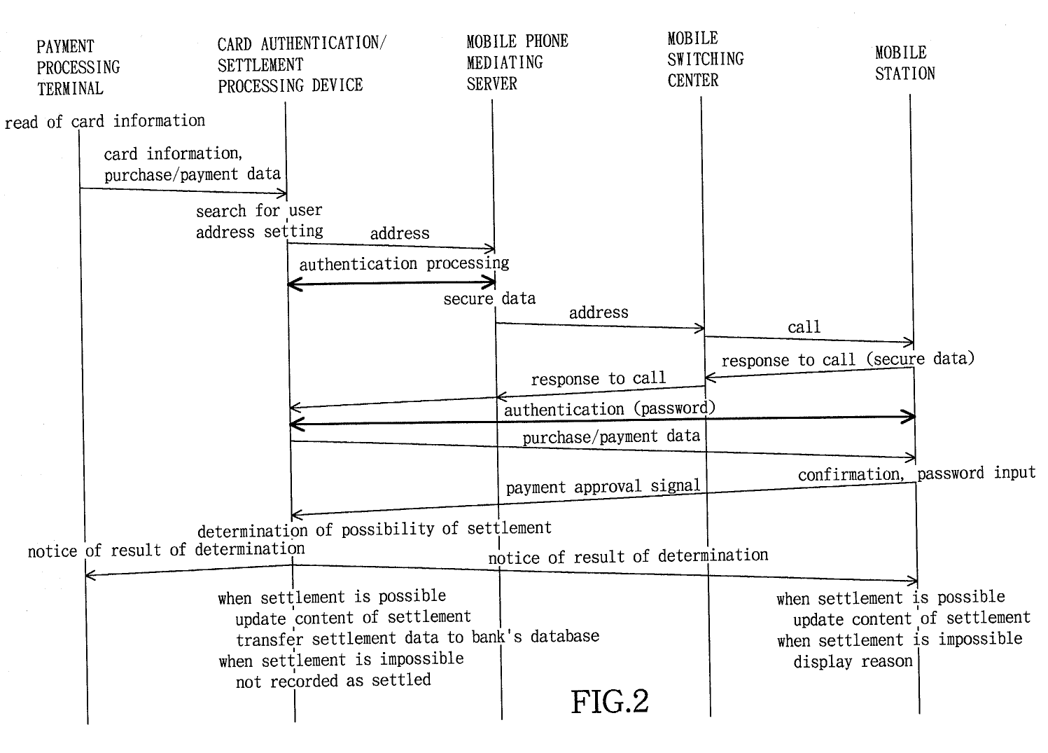

An operation of the embodiment shown in FIG. 1 will be described in detail with reference to FIG. 2. This embodiment will be described with reference to a system utilizing a mobile station stipulated by RCR 27.

When a payment is performed by using a credit card or an IC card, the card is inserted into the payment processing terminal 12 to read a card information (ID and residue, etc.) from the card. In this case, the payment processing terminal 12 sends the card information thus read to the card authentication and settlement processing device 13 together with a purchase and payment data. The card authentication and settlement processing device 13 searches a user from a user information of the credit card or the IC card therein on the basis of the card information, sets an IP (Internet Protocol) address of the called side and accesses the mobile phone mediating server 3 through the communication network 4. In this step, an authentication processing is performed between the card authentication and settlement processing device 13 and the mobile phone mediating server 3 and a processing for securing data to be transferred through the communication network 4 is performed.

The mobile phone mediating server 3 sends the IP address to the mobile switching center 23 connected thereto by the dedicated circuit and the mobile switching center 23 calls a mobile station 21 corresponding thereto through the base station 22. In this case, the mobile switching center 23 performs an authentication of the mobile station 21 through usual radio communication procedure. Further, a securing processing for data in radio circuits is performed.

When the mobile station 21 responds to the call, the card authentication and settlement processing device 13 performs an authentication of the user of the mobile station 21 by using a password or an ID number. When a result of authentication is correct, the card authentication and settlement processing device 13 sends the purchase and payment data to the mobile station 21 responded to the call. When the user of the mobile station 21 confirms the purchase and payment data and inputs the password through the mobile station 21, the payment approval signal is sent to the card authentication and settlement processing device 13 through the mobile phone mediating server 3.

The card authentication and settlement processing device 13 determines whether or not the settlement is possible by comparing the card information (ID and residue, etc.) and the payment approval signal, which are sent thereto, with the database. The result of determination is noticed to the mobile station 21 and the payment processing terminal 12 and displayed thereon, respectively.

When the result of determination is possible, the card authentication and settlement processing device 13 updates the content of settlement in the database thereof and sends the settlement data to the bank's database 5. The transmission system of the settlement data to the bank's database 5 can be set arbitrarily to any of online, offline, immediate and batch systems according to the operating system employed thereby.

When the result of determination is not possible, it is not recorded in the database of the card authentication and settlement processing device 13 as settled. In such case, a reason for impossibility of settlement is displayed on the mobile station 21 together with a warning of shortage of residue, illegal usage of the card by the owner himself or a third party, etc.

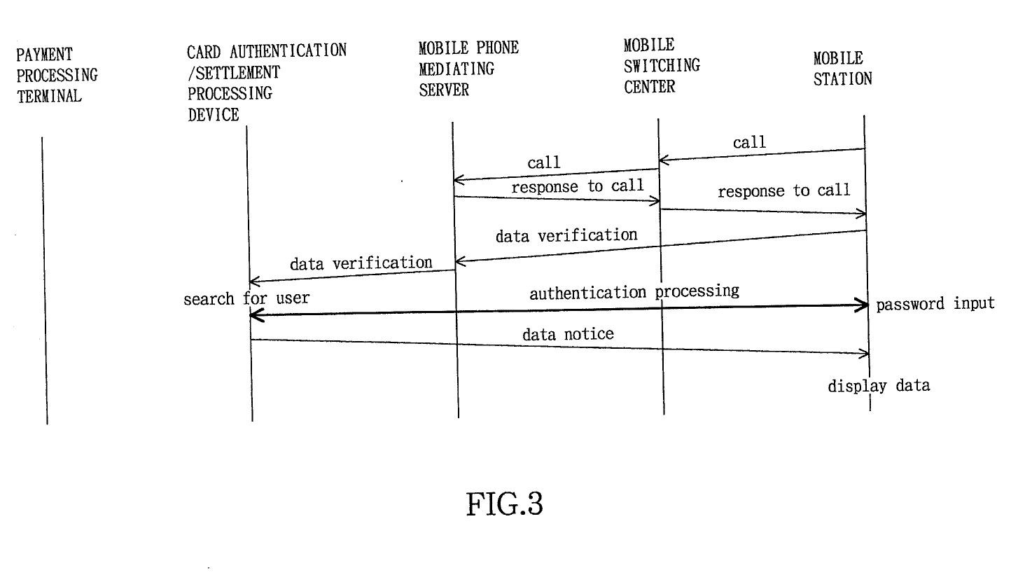

It is possible, by operating the mobile station 21, to verify the information such as a payable limit of the credit card or the residue data of the IC card by accessing the database of the authentication and settlement processing device 13 through the mobile phone mediating server 3. This operation is shown in FIG. 3.

Although the embodiment has been described with reference to the system utilizing the mobile station stipulated by RCR 27, it is possible to construct a system utilizing radio telephone terminals stipulated by other rule than RCR 27, such as PHS, etc.

According to the present invention, it is possible to perform a confirmation of purchase and payment data and an approval of payment through a mobile station, so that it is possible to realize a convenient card settlement system. Particularly, since, when a credit card or an IC card is handed to a store clerk for payment, a handling of the credit card or the IC card by the store clerk can be confirmed through a mobile station, it is possible to realize an inexpensive and safe card settlement system with which the risk such as an illegal copy of card and/or illegal use thereof can be avoided.

Further, since the authentication is performed by the mobile phone system and the card settlement system, it is possible to avoid the risk that the password is stolen by a third person and used illegally.

Further, according to the present invention, it is possible to take a utilization specification of a credit card or an IC card in a mobile station as a direct electronic data and to utilize the specification of utilization as an electronic data.

Further, since the present invention is the system in which the confirmation of purchase and payment data and the payment approval are performed through a mobile station and the authentication of settlement can be done even when an owner of a credit card or an IC card is physically separated from a user of the card, it is possible, for the owner of the card, to make a third person possible to perform a purchase and payment procedure in lieu of the card owner.

What is claimed is:

1. A card utilization approval method comprising the steps of:
calling a mobile station of an owner of a card for settlement of a mobile phone system from a card authentication and settlement processing device upon an input of a card information of the card for settlement; and
performing an authentication of the card and a payment settlement processing of the card in said card authentication and settlement processing device according to a password of the owner of said card inputted from said mobile station called.

2. A card utilization approval method as claimed in claim 1, further comprising the step of performing a mediating of the calling from said card authentication and settlement processing device to the mobile station and a conversion of a format of data from said card authentication and settlement processing device into a format corresponding to a display function of said mobile station, by a mobile phone mediating server provided between said card authentication and settlement processing device and said mobile phone system.

3. A card utilization approval method as claimed in claim 1, further comprising the step of displaying an information including a purchase, a payment and a settlement on said mobile station in detail.

4. A card settlement system comprising a payment processing terminal for reading a card information from a card to be settled and a card authentication and settlement processing device for performing an authentication of a payer and a settlement of payment on the basis of the card information from said payment processing terminal, said card authentication and settlement processing device comprising means for calling a mobile station of an owner of said card in a mobile phone system according to said card information and means for performing an authentication and a confirmation of payment settlement by an input from the called mobile station.

5. A card settlement system as claimed in claim 4, further comprising a mobile phone mediating server for connecting said card authentication and settlement processing device and said mobile phone system mutually and performing a mediation of a calling from said authentication and settlement processing device to a mobile station and a conversion of a format of a data from said card authentication and settlement processing device into a format corresponding to a display function of said mobile station.

6. A card settlement system as claimed in claim 5, wherein said mobile phone mediating server includes means for transferring an information of purchase, payment and settlement from said card authentication and settlement processing device in a format corresponding to the display function of said mobile station.

7. A card authentication and settlement processing device comprising means for calling a mobile station of an owner of a card to be settled in a mobile phone system according to a card information of said card to be settled and means for performing an authentication of said card to be settled and a payment settlement by an input from said called mobile station.
